(19) United States
(12) Patent Application Publication
(10) Pub. No.: US 2010/0320785 A1
(43) Pub. Date: Dec. 23, 2010

(54) Auxiliary Handle for a Tool

(76) Inventor: John Garry Trott, Northern Territory (AU)

Correspondence Address: SHOEMAKER AND MATTARE, LTD, 10 POST OFFICE ROAD - SUITE 100, SILVER SPRING, MD, 20910, US

(21) Appl. No.: 12/517,965

(22) PCT Filed: Dec. 11, 2007
(86) PCT No.: PCT/AU2007/001896

§ 371 Date: Feb. 18, 2010

(30) Foreign Application Priority Data
Dec. 11, 2006 (AU) 2006906890
Feb. 15, 2007 (AU) 2007900734
Jun. 5, 2007 (AU) 2007202569

(51) Int. Cl. B25G 1/00; A01B 1/02

(52) U.S. Cl. 294/58; 81/489

(57) ABSTRACT

The present invention is directed to an auxiliary handle for a shovel, spade and other ground working tools. The auxiliary handle has a relatively long elongate portion that enables a person to comfortably grip the handle relatively close to the implement end while reducing stress on the person's back and providing better leverage.

### FIELD OF INVENTION

The present invention relates to an auxiliary handle for a tool. The present invention has particular but not exclusive application for shovels. The body of the specification describes the auxiliary handle for a shovel by way of example and the invention is not limited to the use with a shovel.

### BACKGROUND OF THE INVENTION

A shovel has a relatively long handle with a blade at one end of the tool. To move soil, snow or other similar material, a person grips the shovel handle close to the blade with one hand and positions the other hand on the handle near the other end. Generally a person places their forward hand close to the blade because less effort is required to lift a load on the blade. In this position the person stoops and bends their back to gain leverage, lift and transfer their shovel load. If a person is in this position for a prolonged period of time, they experience back and shoulder pain and wrist strain. These problems are exacerbated if a person twists while shoveling such as moving a load from a pile to a wheelbarrow.

To address these issues, auxiliary handles have been developed to be used with the shovel handle. An auxiliary shovel handle that is used with the main shovel handle has been disclosed in UK Patent Application Publication No. 2354731. The disclosure describes an auxiliary shovel handle that is attached or attachable to the shovel handle. The auxiliary shovel handle extends upwardly from the shovel handle and provides a grip on the sloping upwardly extending portion. However, the disclosed auxiliary handle appears to be only partially successful in addressing the issues.

### OBJECT OF THE INVENTION

It is an object of the present invention to provide an alternate auxiliary shovel handle that overcomes at least in part one or more of the above mentioned disadvantages.

### SUMMARY OF THE INVENTION

In one aspect the present invention broadly resides in an auxiliary handle fixed or fixable to a tool which has a handle and a head, said auxiliary handle has a first portion and a second portion spaced apart by an elongate portion, the first portion is relatively longer than the second portion, the elongate portion is relatively longer than the first portion; wherein when the auxiliary handle is fixed to the tool, the first portion is adjacent a head of the tool and a first intermediate section that is formed at the intersection of the first portion and the elongate portion, is spaced furthermost from the tool.

The tool is defined in the specification to be a shovel, a spade, a fork or other similar ground working tools. The head is defined in the specification to include an implement portion such as the shovel or spade blade and the tangs of the fork. The head may also include a sleeve portion.

The first intermediate section is preferably spaced furthermost from the tool handle.

The second portion and the elongate portion preferably form a second intermediate section that is spaced relatively closer to the tool handle than the first intermediate section.

The elongate portion is preferably straight and longitudinally aligned with the tool handle when fixed to the tool. The elongate portion preferably has a grip section that is part of or adjacent to the first intermediate section. The auxiliary handle preferably has a relatively long elongate portion that enables a person to comfortably grip the handle relatively close to the implement end while reducing stress on the person's back and providing better leverage.

The first intermediate section preferably forms a bend that prevents a user's hand from sliding forward.

Preferably, a substantially 90 degrees or larger angle is formed between the first portion and the elongate portion. A substantially obtuse angle is preferably formed between the second portion and the elongate portion.

The first portion preferably has a first portion end that is fixed or fixable to the tool. The first portion preferably has a first portion end fixed or fixable to the tool that when fixed is proximal to the tool head.

Preferably, the first portion end is fixed or fixable to the head of the tool. In one preferred embodiment, the first portion end is fixed or fixable to the sleeve portion.

In another embodiment, the first portion end is fixed or fixable to the implement portion of the head.

The second portion may or may not be fixed or fixable to the tool. In one preferred embodiment, the second portion end is not fixed or fixable to the tool handle and there is a gap between a second portion end of the second portion and the tool handle. The gap is preferably between 1 and 100 mm. Preferably the first portion is releaseably clamped to the tool and the second portion does not contact the tool when in position. In this way the auxiliary handle can be easily removed from one tool and fitted to another tool.

In another embodiment the first portion has a first portion end that is fixed or fixable to the tool and the second portion has a second portion end that is fixed or fixable to the tool.

The first, second and elongate portions are preferably formed with a single pipe section. The auxiliary handle may be made of metal or plastics material. Alternately, the auxiliary handle is preferably an elongate section of plastics material. More preferably the auxiliary handle is a substantially cylindrical elongate section of plastics material.

Preferably the auxiliary handle as described above can be retrofitted to existing tools such as shovels, spades and forks.

In another aspect the present invention broadly resides in a tool having an auxiliary handle as described above.

In one embodiment of the tool, the auxiliary handle is permanently fixed to the tool.

In another embodiment of the tool, the auxiliary handle is releaseably fixed to the tool.

### BRIEF DESCRIPTION OF THE DRAWINGS

In order that the present invention can be more readily understood reference will now be made to the accompanying drawings which illustrate preferred embodiments of the invention and wherein:

FIG. 1 is a diagrammatic side view of an auxiliary handle permanently fixed to a shovel according to a first embodiment of the present invention;

FIG. 2 is a diagrammatic side view of an auxiliary handle permanently fixed to a shovel according to a second embodiment of the present invention;

FIG. 3 is a diagrammatic side view of an auxiliary handle permanently fixed to a shovel according to a third embodiment of the present invention;

FIG. 4 is a diagrammatic side view of an auxiliary handle permanently fixed to a shovel according to a fourth embodiment of the present invention;

FIG. 5 is a diagrammatic view of an auxiliary handle permanently fixed to a shovel according to a fifth embodiment of the present invention;

FIG. 6 is a diagrammatic view of an auxiliary handle clamped to a shovel according to a sixth embodiment of the present invention;

FIG. 7 is a diagrammatic side and partial view of a shovel with an auxiliary handle of FIG. 6;

FIG. 8 is a diagrammatic view of the auxiliary handle of FIG. 6; and

FIG. 9 is a diagrammatic view of an auxiliary handle clamped to a shovel according to a seventh embodiment of the present invention.

### DETAILED DESCRIPTION OF THE PREFERRED EMBODIMENTS

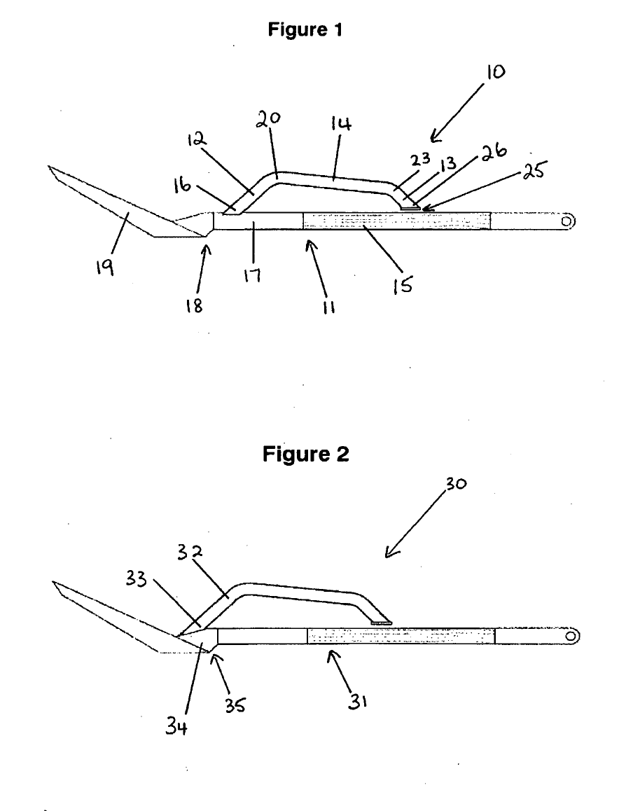

With reference to FIG. 1, there is shown a first embodiment of an auxiliary handle 10 that is permanently fixed to a shovel 11. The auxiliary shovel handle 10 is a continuous pipe that has a front portion 12 and a rear portion 13 spaced apart by an elongate portion 14. The auxiliary shovel handle 10 is a continuous pipe of approximately 250 mm in length and 20 to 50 mm thick. The elongate portion 14 is longitudinally aligned with the handle 15 of the shovel 11. The front portion 12 has a front end 16 that is welded to the sleeve 17 of the shovel head 18.

The front portion 12 and the elongate portion 14 form a front arcuate section 20 that is spaced furthermost from the handle 15 of the shovel 11. The rear portion 13 and the elongate portion 14 forms a rear arcuate section 23 that is spaced relatively closer to the handle 15 than the front arcuate section 20. The configuration of the higher front arcuate section 20 and the lower rear arcuate section 23 is determined by the relative lengths of the front portion 12 and rear portion 13 and their angle formed relative to the elongate portion 14. The front portion 12 is longer than the rear portion 13, and the elongate portion 14 is longer than the front portion 12. The long elongate portion 14 provides enough room for a person to place and adjust their hand on the elongate portion 14 to form a comfortable grip and position their hand relatively close to the shovel blade 19 for improved leverage.

Each one of the front 12 and rear 13 portions form a substantially obtuse angle with the elongate portion 14. The angle between the front portion 12 and the elongate portion 14 can be varied to alter the height of the front arcuate section 20 relative to the handle 15.

The rear portion 13 is not fixed to the handle 15. There is a gap 25 between the rear end 26 of the rear portion 13 and the handle 15. The gap 25 is between 1 and 100 mm.

With reference to FIG. 2, there is shown a second embodiment of the auxiliary handle 30 that is permanently fixed to a shovel 31. The auxiliary handle 30 is similar to the auxiliary handle 10 described above except that the front portion 32 has a front end 33 that is welded to the shovel blade 34 of the shovel head 35. Positioning the auxiliary handle 30 closer to the shovel blade enables a person to position their grip closer to the shovel blade. A grip closer to the shovel blade reduces the effort needed to lift the load on the shovel blade and provides better leverage.

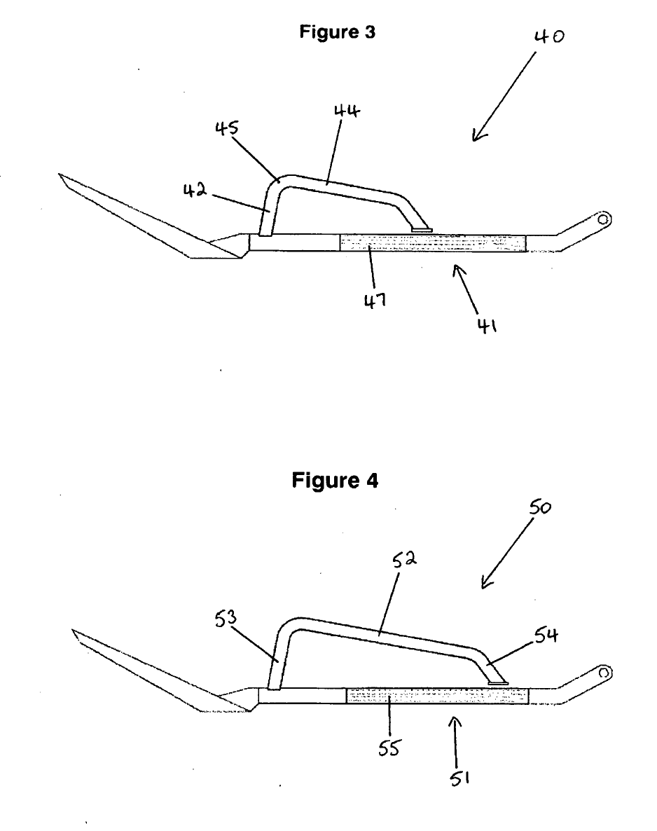

With reference to FIG. 3, there is shown a third embodiment of the auxiliary handle 40 that is permanently fixed to a shovel 41. The auxiliary handle 40 is similar to the auxiliary handle 10 described above except that the angle formed between the front portion 42 and the elongate portion 44 is about 90 degrees. Varying the angle between the front portion 42 and the elongate portion 44 has the effect of altering the height of the front arcuate section 45 relative to the handle 47. The front arcuate section 45 is spaced further from the handle 47 when there is a decreased angle. A higher front arcuate section allows a person to grip the auxiliary handle while minimizing the amount of bending required by the person and thus reducing the stress on the person's back.

With reference to FIG. 4, there is shown a fourth embodiment of the auxiliary handle 50 that is permanently fixed to the shovel 51. The auxiliary handle 50 is similar to the auxiliary handle 40 except that the elongate portion 52 is longer than the elongate portion 44 of the auxiliary handle 40. A long elongate portion 52 provides the advantage of positioning the front and rear portions 53,54 sufficiently far apart so that a person can still grip along a substantial length of the handle 55 and not be obstructed by the front and rear portions 53,54. The ability of the person to adjust their grip along the length of the main handle is important when the person wants to remove loose material like sand from a high position such as from the back of a truck while standing on the ground.

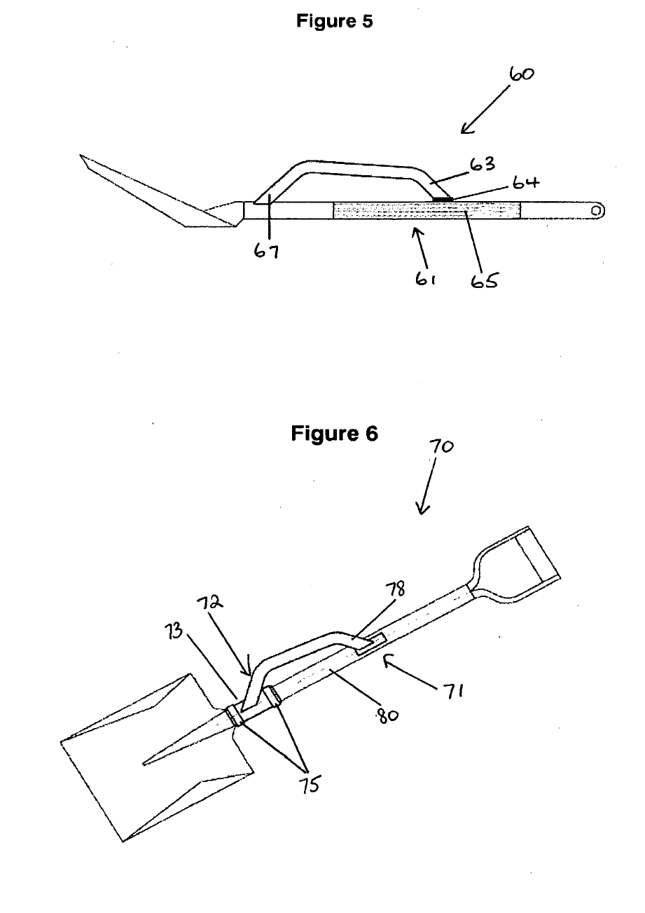

With reference to FIG. 5, there is shown a fifth auxiliary handle 60 that is permanently fixed to the shovel 61. The auxiliary handle 60 is similar to the auxiliary handle 10 described above except that the rear portion 63 has a rear end 64 that is welded to the handle 65. Welding the auxiliary handle 60 to the handle 65 at both the front and rear ends 67,64 has the advantage of providing a sturdier auxiliary handle.

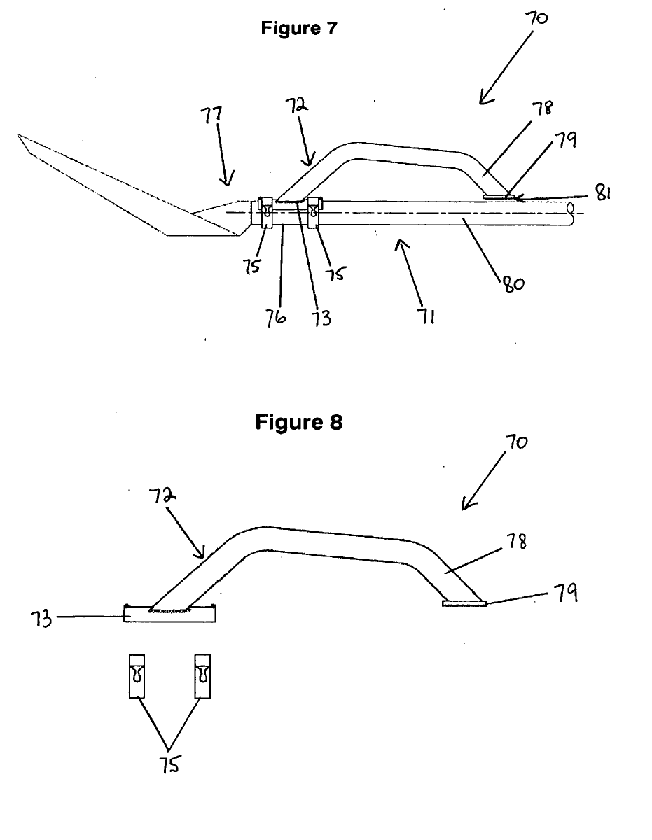

With reference to FIGS. 6 to 8, there is shown a sixth auxiliary handle 70 that is releaseably fixed to the shovel 71 by the front portion 72 being clamped to the shovel 71. The front portion 72 has a bracket 73 that is clamped by clamps 75 to the sleeve 76 of the shovel head 77. The auxiliary handle 70 has a rear portion 78 with a rear end 79 that is not fixed to the handle 80 of the shovel 71. There is a gap 81 of about 1 and 100 mm between the rear end 79 and the handle 80. An auxiliary handle that is releaseably fixed to the shovel provides a convenient way of attaching and detaching the auxiliary handle from the shovel for replacement purposes.

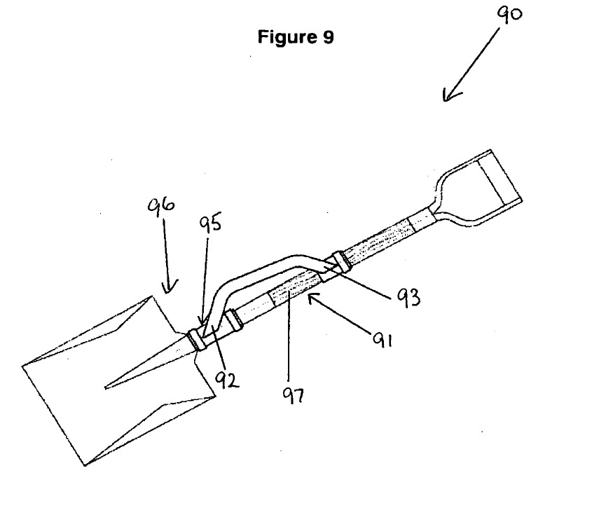

With reference to FIG. 9, there is shown a seventh auxiliary handle 90 that is releaseably fixed to the shovel 91 by being clamped to the shovel 91. The auxiliary handle 90 is similar to the auxiliary handle 70 described above, except that both the front end 92 and rear end 93 are fixed by being clamped to the shovel 91. The front end 92 includes a bracket that is clamped to the sleeve 95 of the shovel head 96, and the rear end 93 includes a bracket that is clamped to the handle 97. In other embodiments of the auxiliary handle, not shown in the figures, bolts, screws or rivets may be used to fasten an auxiliary handle to the shovel.

### ADVANTAGES

An advantage of an embodiment of the auxiliary handle is that a relatively long elongate portion enables a person to comfortably adjust their grip on the elongate portion to a position that is close to the shovel or tool blade.

Another advantage of an embodiment of the auxiliary shovel handle is that a front arcuate section spaced furthermost from the shovel handle enables a person to grip the shovel without bending too low. The reduced stoop of the person when shoveling material reduces the stress on the person's back and shoulders.

A further advantage of an embodiment of the auxiliary shovel handle is that a larger incline of the elongate portion relative to the shovel handle reduces the stress on the person's wrist.

The embodiments of the auxiliary handle that are releaseably fixed to the shovel provide the advantage of being conveniently attached and detached from the shovel for replacement purposes. Furthermore, existing shovels or other similar ground working tools that do not have an auxiliary handle can be retrofitted with an auxiliary handle.

### VARIATIONS

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

1-11. (canceled)

12. An auxiliary handle fixed or fixable to a tool which has a handle and a head, said auxiliary handle has a first portion and a second portion spaced apart by an elongate portion, the first portion is relatively longer than the second portion, the elongate portion is relatively longer than the first portion, a first intermediate section is formed at the intersection of the first portion and the elongate portion; wherein when the auxiliary handle is fixed to the tool, the first portion is adjacent a head of the tool, the elongate portion is substantially straight and longitudinally aligned with the tool handle and the first intermediate section is spaced furthermost from the tool.

13. An auxiliary handle as claimed in claim 12, wherein the auxiliary handle is formed with a single tubular section.

14. An auxiliary handle as claimed in claim 12, wherein the first intermediate section forms a bend that prevents a user's hand from sliding forward.

15. An auxiliary handle as claimed in claim 12, wherein at least the first portion is fixed or fixable to the tool handle.

16. An auxiliary handle as claimed in claim 12, wherein the first portion has a first portion end that is fixed or fixable to the tool while the second portion is not fixed to the tool.

17. An auxiliary handle as claimed in claim 12, wherein the first portion has a first portion end that is fixed or fixable to the tool and the second portion has a second portion end that is fixed or fixable to the tool.

18. An auxiliary handle as claimed in claim 12, wherein the first portion has a first portion end that is fixed or fixable to the tool head.

19. An auxiliary handle as claimed in claim 12, wherein the elongate portion has a grip section that is part of or adjacent to the first intermediate section.

20. An auxiliary handle as claimed in claim 12, wherein the first intermediate section has a substantially 90 degrees or larger angle between the first portion and the elongate portion.

21. An auxiliary handle as claimed in claim 12, wherein the tool is a shovel, spade, fork or other ground working implement.

22. An auxiliary handle as claimed in claim 12, wherein the first portion is releaseably fixed or fixable to the tool and the handle can be easily removed from one tool and fixed to another tool.

23. An auxiliary handle as claimed in claim 12, wherein the first portion is releaseably clamped to the tool and the second portion does not contact the tool when in position.

24. A tool with an auxiliary handle as claimed in claim 12, said tool being a shovel, spade, fork, or other ground working implement.
